(19) United States
(12) Patent Application Publication
(10) Pub. No.: US 2011/0289103 A1
(43) Pub. Date: Nov. 24, 2011

(54) METHOD AND SYSTEM OF SEARCHING ACCOUNTS BY ARRANGING PHONE NUMBERS

(75) Inventors: Yu Chen, Taipei (TW); Chia-Ching Lee, Taipei (TW)

(73) Assignee: Shuttle Inc., Taipei (TW)

(21) Appl. No.: 12/836,644

(22) Filed: Jul. 15, 2010

(30) Foreign Application Priority Data
May 24, 2010 (TW) 099116563

(51) Int. Cl. G06F 17/30

(52) U.S. Cl. 707/769; 707/E17.014; 707/781; 707/E17.005

(57) ABSTRACT

The present invention discloses a method and system of searching accounts by arranging phone numbers. An individual user table is set up in a general user database and the individual user table includes predetermined phone numbers and predetermined accounts. In addition, each predetermined phone number has at least one corresponding predetermined account. The system will search and show the corresponding predetermined account or the corresponding predetermined phone number after a phone number or an account is input.

### BACKGROUND OF THE INVENTION

1. Technical Field

The present invention relates to a method and a system of searching accounts by arranging phone numbers, and particularly to a method and a system for integrated management of phone numbers and accounts.

2. Description of Related Art

In the age where the applications of network technology have been popularized, email communication and instant messaging applications are widely used as mainstream communication tools in addition to telephonic devices, for their advantages of being fast, accurate and free from limitations in time and space.

There are many Internet-based service providers allotting email addresses to their users for free and there are many people who maintain business email addresses apart from their personal email addresses. Thus, it is normal that one person will have more than two email addresses. When sending an email to such a person, the addresser has to input each of the email addresses, creating more work and inconvenience. In the meantime, as typos will occur from time to time, once the wrongly input email addresses are applied as accesses in business emails, the addresser can not only lose time, but also irredeemably damage the integrity of confidential information.

On the other hand, instant messaging applications are also a popular form of internet-based communication service as described above, such as MSN, YAHOO Messenger, SKYPE or QQ which is popular in China. When a user of such an application intends to incorporate an individual's communicating account into his/her contact list, the conventional approach is to directly input the account information to the application. However, an incorrect input may cause an unknown third party to be unintentionally incorporated into the contact list, leading to trouble for both parties. Alternatively, a name or a nickname may be used for a search. However, when there is a plurality of accounts with the same name or nickname shown as the search result, careful identification has to be made in order to prevent mistaking certain people with others. Furthermore, if a person uses different accounts in different messaging applications, the search could be even harder.

In addition, there are many social community service means, such as blogs, FACEBOOK, and so on, which give users a platform to publish and share with others images, videos or articles made by himself/herself. The search for users in this kind of social community service can be also achieved by inputting accounts or nicknames. However, similar to the foregoing instant messaging applications, when a user intends to add another user to his/her contact list, incorrect input is still a problem, not to mention the problems that occur when one person uses varying accounts in different social community services.

### SUMMARY OF THE INVENTION

The present invention provides a method and a system of searching accounts by arranging phone numbers. Thereby, an inquiring user can input a phone number of a user to be searched and easily obtain the corresponding email address, instant messaging account or social community service account, and can directly apply the search result to an appointed field in an associated application, without the need of searching and typing in the account information one by one. Hence, the problems related to the incorrect input of account information can be eliminated and the search can be more efficient. To people who have trouble in reading the alphabet, the present invention is user-friendly because the inquiring user only has to key in phone numbers which are more visually recognizable as compared with other characters, thereby saving time and energy. Additionally, the present invention allows an inquiring user to search a phone number with a known account, so as to enhance operational convenience.

For achieving the above effects, the present invention provides a method of searching accounts by arranging phone numbers, which comprises steps of providing a general user database that has at least one individual user table that includes a plurality of predetermined phone numbers and a plurality of predetermined accounts, wherein each said predetermined phone number has at least one corresponding said predetermined account; inputting a phone number or an account for a search; and searching the phone number or the account in the general user database and showing at least one said predetermined account or at least one said predetermined phone number.

Therein, the predetermined phone number corresponding to the shown predetermined account is identical to the phone number previously input for a search, and the predetermined account corresponding to the shown predetermined phone number is identical to the account previously input for search.

For achieving the above effects, the present invention further provides a system of searching accounts by arranging phone numbers, which comprises an inquiring user interface including an input unit; a general user database storing at least one individual user table, which includes a plurality of predetermined phone numbers and a plurality of predetermined accounts, wherein each said predetermined phone number has at least one corresponding said predetermined account; and a search unit connected to the general user database and including at least one search field, wherein, when a phone number or an account for search is input to the search field of the input unit, the search unit searches in the general user database and shows at least one said predetermined account or at least one said predetermined phone number.

Therein, the predetermined phone number corresponding to the shown predetermined account is identical to the phone number previously input for search, and the predetermined account corresponding to the shown predetermined phone number is identical to the account previously input for search.

In addition, the present invention may further be connected to an authorization unit for security management where only authorized inquiring users are allowed to have access, and where a notice is issued by the authorization unit to an account provided by a user who has previously input his/her data, and the setting of the general user database will only be completed when the user acknowledges this notice, so as to prevent problems related to unintentional incorrect input of the account.

By implementing the present invention, at least the following progressive effects can be achieved:

1. By merely inputting the phone number to be searched, the desired account information can be obtained, so as to eliminate problems involving incorrect input of accounts or other contacting information.

2. The present invention can work with applications where search of accounts is required for building a contact list. When the phone number to be searched is input to the associated application, search in the general user database of the present invention is conducted and the result is shown in the associated application, thereby simplifying the process of adding contacts.

3. The inquiring user can input an account for searching the phone number corresponding thereto, so as to allow convenient inquiry.

4. The present invention can incorporate security management, so as to limit users' access and ensure information security.

5. The information is maintained and updated by individual users. When there is a change to be made, the user can simply modify the information stored in the general user database and other users can be updated without separate notification, thus rendering the system to be far more convenient.

### BRIEF DESCRIPTION OF THE DRAWINGS

The invention as well as a preferred mode of use, further objectives and advantages thereof will be best understood by reference to the following detailed description of illustrative embodiments in conjunction with the accompanying drawings, wherein:

FIG. 1 is a block diagram of a system of searching accounts by arranging phone numbers according to one embodiment of the present invention;

FIG. 2 is an exemplifying individual user table for a method of searching accounts by arranging phone numbers according to the present invention;

FIG. 3 is a block diagram of a system of searching accounts by arranging phone numbers according to another embodiment of the present invention;

FIG. 4 through FIG. 8 show exemplifying individual user tables for the method of searching accounts by arranging phone numbers according to the present invention;

FIG. 9 is a flowchart of the method of searching accounts by arranging phone numbers according to one embodiment of the present invention; and

FIG. 10 is a flowchart of the method of searching accounts by arranging phone numbers according to another embodiment of the present invention.

### DETAILED DESCRIPTION OF THE INVENTION

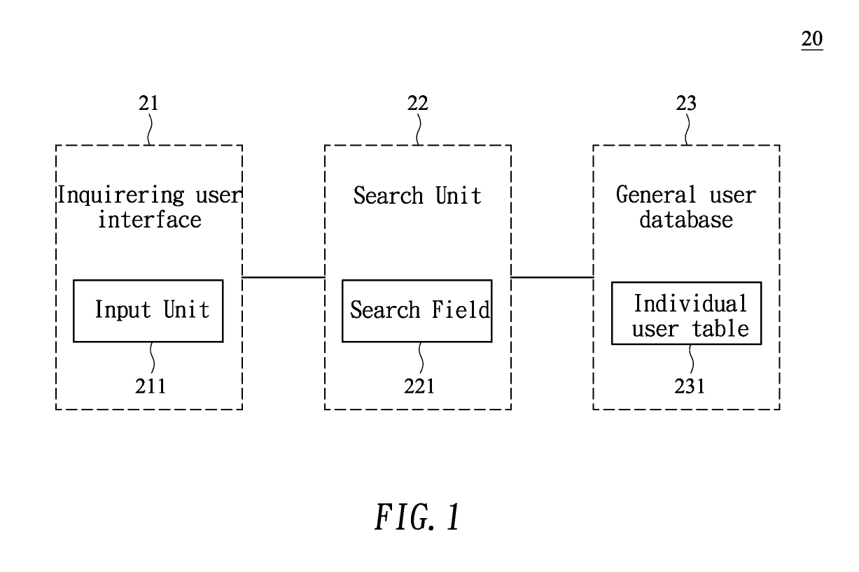

Referring to FIG. 1, the present invention provides a system 20 of searching accounts by arranging phone numbers, which comprises an inquiring user interface 21, a general user database 23, and a search unit 22.

Therein, the inquiring user interface 21 has an input unit 211 that allows an inquiring user to input contents therethrough for a search.

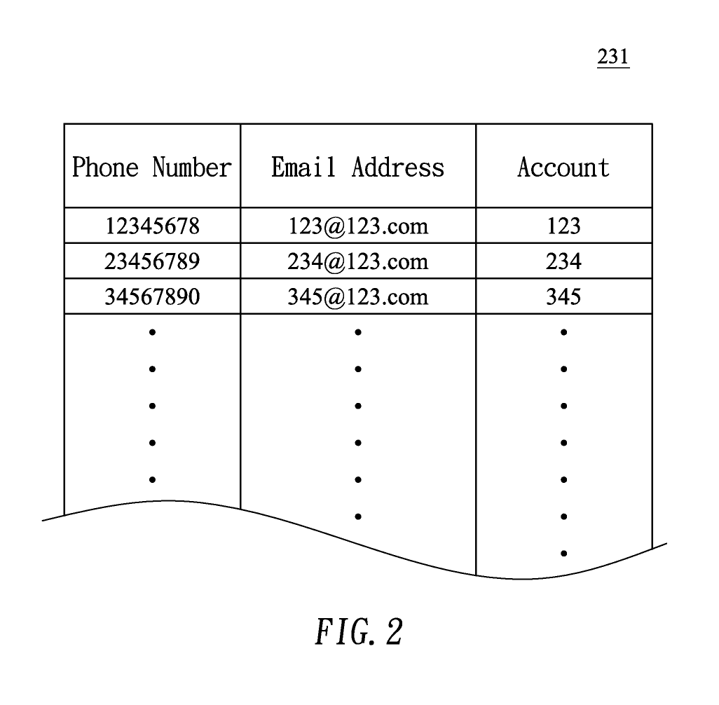

Please see FIG. 2 also for an individual user table 231 in the form of a mapping table. The general user database 23 stores therein at least one individual user table 231. The individual user table 231 includes a plurality of predetermined phone numbers and accounts. Therein, each of the predetermined phone numbers has at least one corresponding predetermined account. After being established, the individual user table 231 may be updated by its user to upload information to the system 20, so as to stay updated.

The search unit 22 is connected to the general user database 23 and has at least one search field 221. According to a corresponding condition input to the search field 221 through the input unit 211 by an inquiring user, the search unit 22 searches in the general user database 23 for corresponding said phone number(s) or account(s), and then shows the corresponding said phone number(s) or account(s). The inquiring user directly can obtain the corresponding said phone number(s) or account(s) without the need to input account information one by one. The general user database 23 may be built in a host or connected to the system 20 through a network, so as to allow update made by the individual users and in turn maintain good authenticity of the data therein.

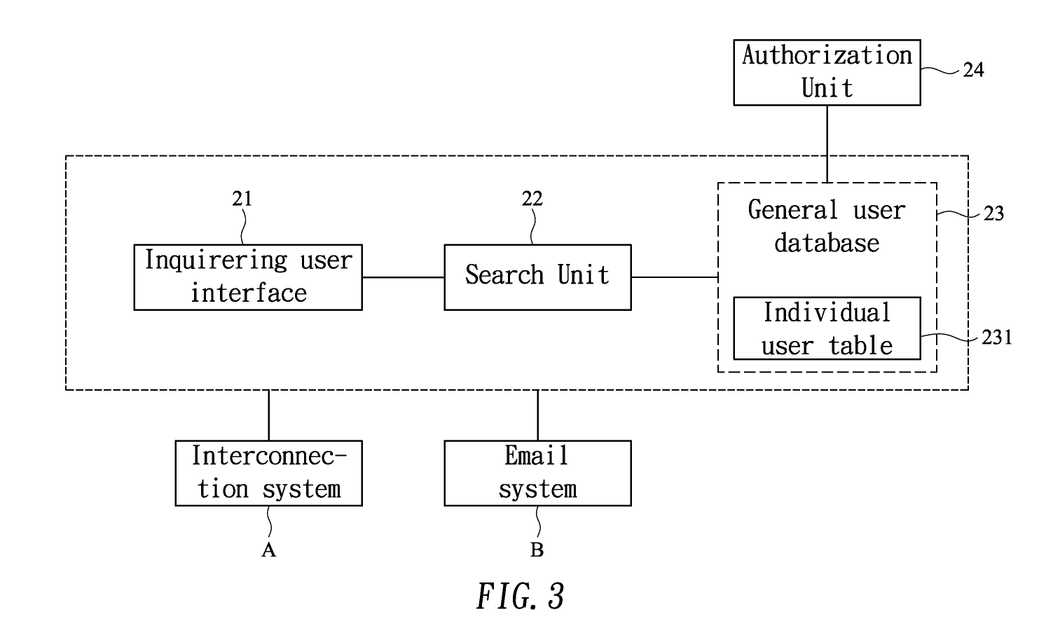

As shown in FIG. 3, the general user database 23 may be connected to an account search field of an interconnection system A or to an account search field of an email system B, for facilitating the inquiring users' operation.

The general user database 23 is further connected to an authorization unit 24, so that when a user uploads information to the individual user table 231 for a registration process or an update process, the authorization unit 24 issues a confirmation to an account previously provided by the user, and the general user database 23 will only complete the registration process or update process until the user acknowledges the confirmation. Thereby, problems related to incorrect account input can be eliminated. In addition, the user may previously build a list of persons who are desired to be authorized inquiring users for search, and then a notice is issued to each said person. In such a case, when the person receives and confirms the notice, he/she is allowed to conduct search in the general user database 23 as an authorized inquiring user. Similarly, if a user intends to perform search for another user's information, he/she may issue a request and the authorization unit 24 can send a notice to the account registered by the user to be found. After the user to be found agrees to give the authorization, the system 20 will allow the inquiring user to conduct the requested search.

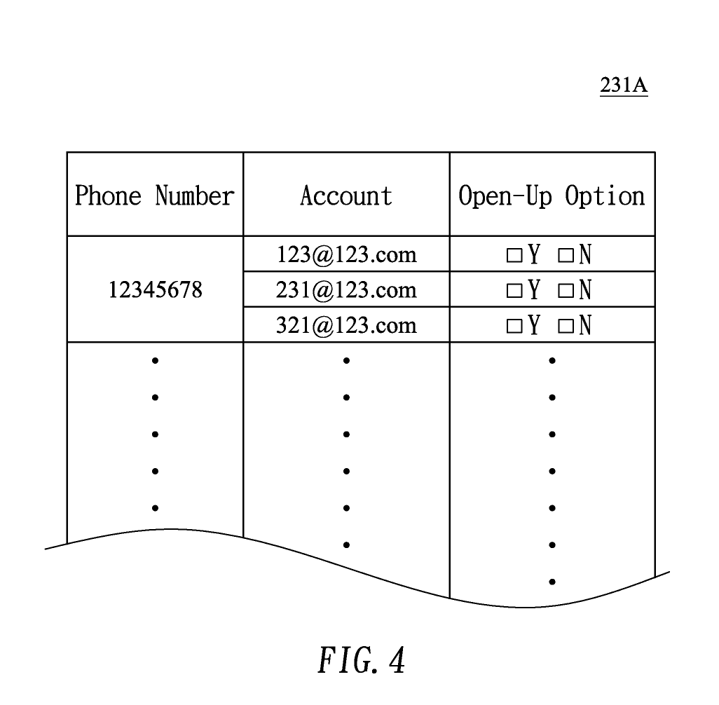

Furthermore, referring to FIG. 4, the individual user table 231A may further have an open-up setting field, so that each said predetermined account has an open-up setting option. Thereby, the user is allowed to set up his/her individual predetermined accounts to either be opened up or closed as a response to a search. Thus, as a result of the search, only the enabled accounts are shown, so as to improve manageability. Of course, the user may open up only one said account or open up a plurality of said accounts as desired.

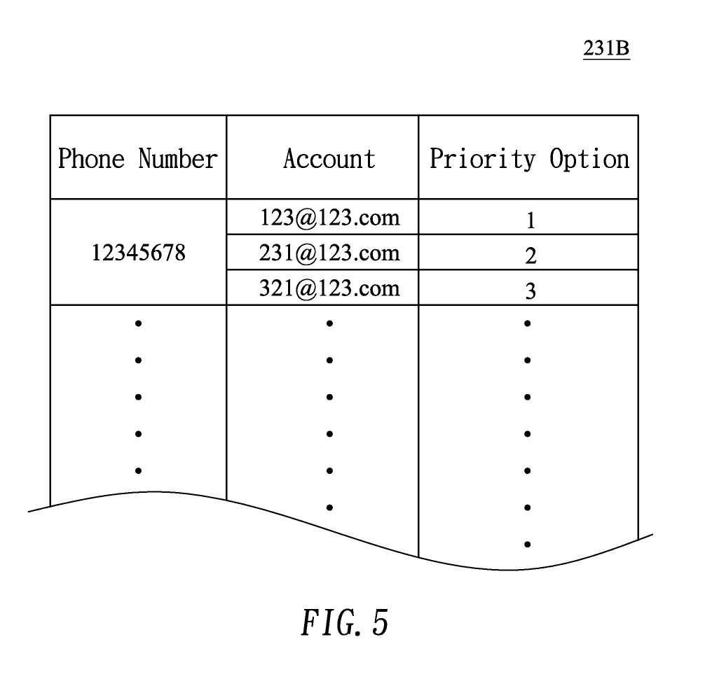

Referring to FIG. 5, the individual user table 231B may further have a priority setting field, so that each said predetermined account has a priority setting field option. Thereby, the user is enabled to set up a priority order by which to show the predetermined accounts, and set the predetermined account with the top priority as an account to be shown, so that when an inquiring user inputs the corresponding phone number for a search, only this predetermined account of the top priority will be shown.

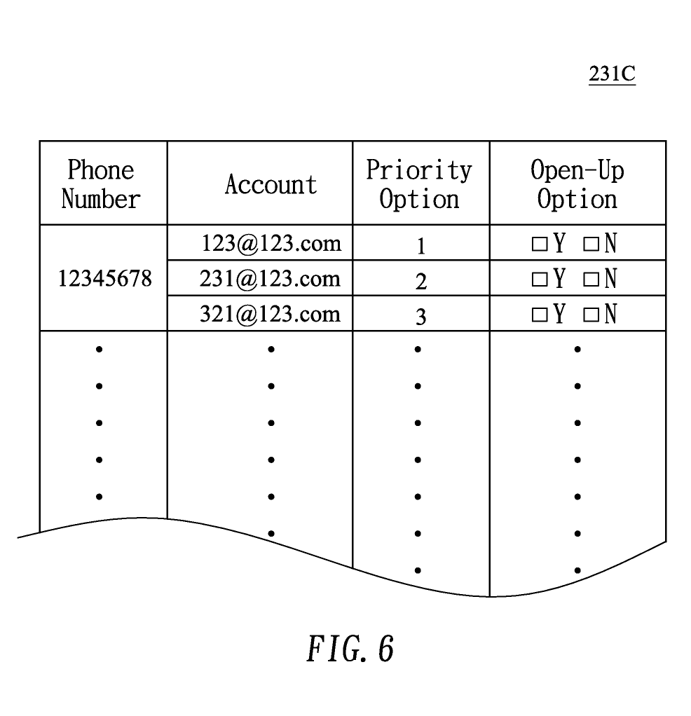

Referring to FIG. 6, the individual user table 231C may have both the open-up setting field and the priority setting field. When an inquiring user inputs the corresponding phone number for search, the corresponding accounts can be shown in order according to the options made in the open-up setting field and the priority setting field.

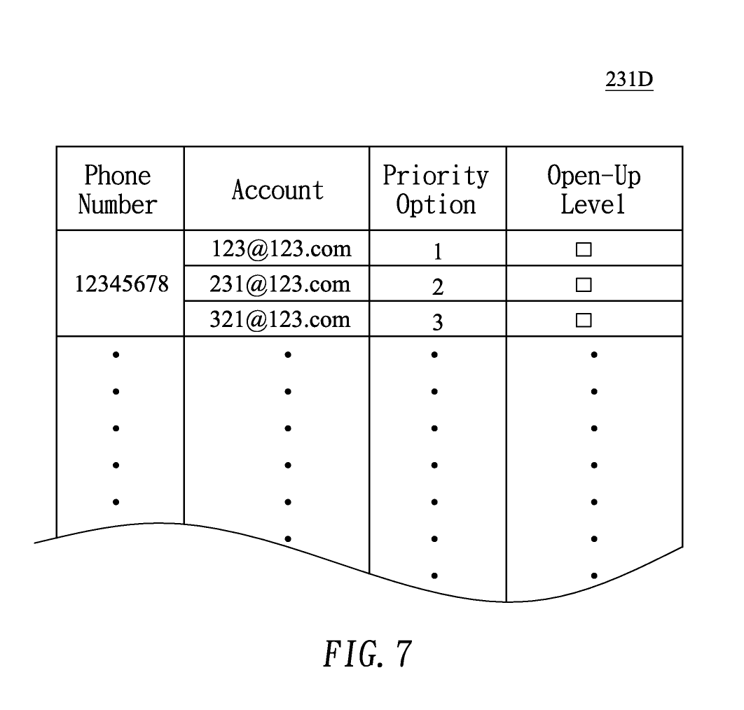

As shown in FIG. 7, the individual user table 231D may further have an open-up priority setting field, which is configured to work with the foregoing priority setting field. The user may set in the open-up priority setting field for displaying up to the account of the n^{th} priority (n is a natural number greater than 1). When an inquiring user inputs the corresponding phone numbers for search, the accounts from the top priority through the n^{th} priority will be displayed. For instance, when the user makes the setting in the open-up priority setting field as the second priority, only the accounts of the first and the second priority will be shown in response to inquiring users' search.

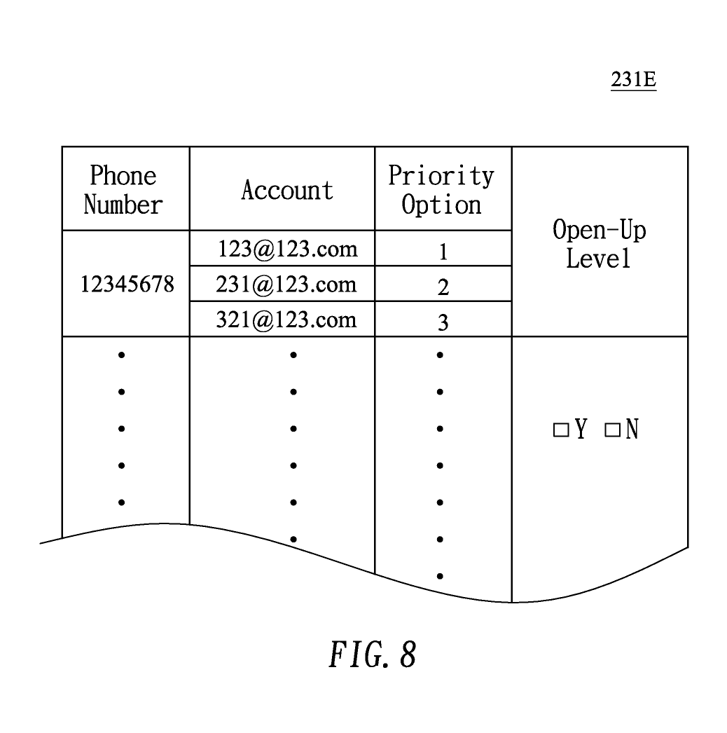

Additionally, referring to FIG. 8, the user may directly input a number at the head of the open-up priority setting field of the individual user table 231E, and further check to enable or disable this function. If the function is disabled, only the top priority account will be given, so as to enhance operational convenience.

Moreover, the open-up setting field, the priority setting field, and the open-up priority setting field may be in the form of a drop-down menu, or may provide multiple check boxes or other applicable input means, which is not limited to the one shown in the drawings.

Furthermore, when the system 20 shows multiple accounts in the email system B according to the input conditions, the inquiring user may again check the applied account before sending an email, or the inquiring user may adopt all the shown accounts in order to ensure successful delivery even when one or some of the searched accounts are overloaded or invalid.

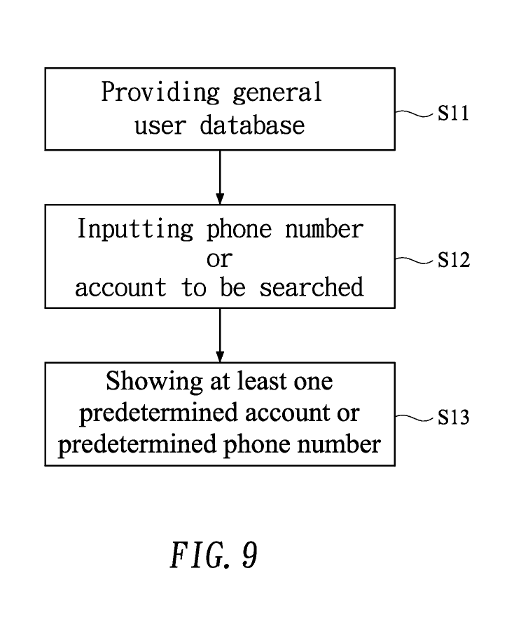

Hereinafter, an embodiment of a method of searching accounts by arranging phone numbers according to the present invention is illustrated. Referring to FIG. 9, the method comprises steps of: providing a general user database (S11); inputting a phone number or an account for search (S12); and showing at least one predetermined account or predetermined phone number (S13).

Therein, the phone number to be searched corresponds to the predetermined account in the general user database 23 and is identical to the predetermined phone number in the general user database 23, while the account to be searched corresponds to the predetermined phone number in the general user database 23 and is identical to the predetermined account in the general user database 23.

In the step of providing the general user database (S11), the general user database 23 is stored in at least one individual user table 231, which is in the form of a mapping table. Referring to FIG. 2, the individual user table 231 includes a plurality of predetermined phone numbers and a plurality of predetermined accounts. Therein, each said predetermined phone number has at least one corresponding predetermined account. The individual user table 231 is to be built and maintained by users so as to ensure that the individual user table 231 remains updated.

In the step of inputting the phone number or account to be searched (S12), a condition may be input by an inquiring user for searching any corresponding phone number or account in the general user database 23.

In the step of showing at least one predetermined account or predetermined phone number (S13), in response to the input of the phone number to be searched, search is conducted in the general user database 23 and the corresponding predetermined account is shown. Similarly, in response to the input of the account to be searched, the corresponding predetermined phone number is shown for the inquiring user to use.

Therein, the phone number to be searched is corresponding to the predetermined account in the general user database 23 and is identical to the predetermined phone number in the general user database 23, while the account to be searched is corresponding to the predetermined phone number in the general user database 23 and is identical to the predetermined account in the general user database 23.

In the above-disclosed method, by using a user's phone number for search, an inquiring user can obtain the corresponding predetermined one or more accounts. The predetermined account may be an email address, so as to eliminate problems related to inputting incorrect letters in the email address. In addition, the general user database 23 may be in a host or connected to the system 20 through a network, so as to enable updates and by the users and in turn to maintain good authenticity of the data therein.

Furthermore, the present embodiment is further connected to an account search field of an interconnection system A. The interconnection system A may be an instant messaging application or a social community service (e.g. MSN, FACEBOOK, etc.). When a phone number is input into the account search field of the interconnection system A, search is conducted in the general user database 23, and the corresponding at least one predetermined account is directly shown in the interconnection system A. Thereby, the inquiring user can promptly be informed of the searched account for his/her use.

Furthermore, the present embodiment is further connected to an account search field of an email system B (e.g. MS Outlook etc.). When a phone number is input to the account search field of the email system B, search is conducted in the general user database 23, and the corresponding at least one predetermined account is directly shown in the email system B. Thereby, the inquiring user can directly apply the searched account to the addressee field of an email, so as to prevent mistyping of the email address.

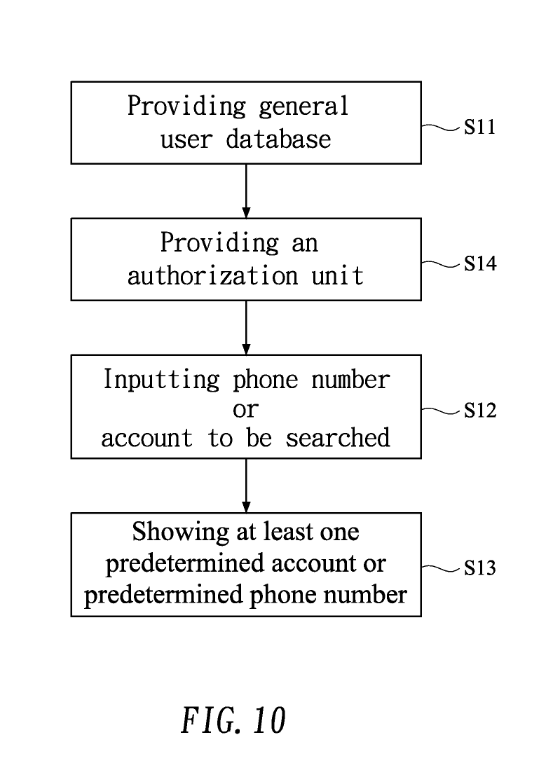

As shown in FIG. 10, the present embodiment further comprises providing an authorization unit (S14). Therein, the user uploads his/her personal individual user table 231 for a registration process or an update process. Then the authorization unit 24 issues a confirmation to an email address previously provided by the user, and the general user database 23 will only complete the registration process or update process until the user acknowledges the confirmation, so as to prevent problems related to incorrect input of the email address.

In addition, if it is desired to allow other inquiring users to access the individual user's information, the individual user may previously set up a list of persons who are desired to be authorized inquiring users for search, and then a notice is issued to each said person. In such a case, when the person receives and confirms the notice, he/she is allowed to conduct a search as an authorized inquiring user in the general user database 23. Similarly, if the user intends to perform search as an inquiring user for another individual user's information, he/she may request so and the authorization unit 24 sends a notice to the email address registered by said individual user. After the contacted individual user agrees to give the authorization, the system 20 will allow the requested search in the general user database 23. This is for ensuring information security.

Referring to FIG. 4 through FIG. 8, the individual user table 231A may further have an open-up setting field for the user to select which accounts to show while filling in the individual user table 231A. With this setting, other inquiring users can only see the accounts the user wants to show.

Additionally, the individual user table 231B may further have a priority setting field for the user to set the order of his/her accounts while inputting the accounts, so that the predetermined accounts will be shown in the priority order set by the user. For easy operation, the user may only allow the predetermined account of the first priority to be shown. Furthermore, the individual user table 231C may have both the open-up setting field and the priority setting field, so as to allow setting for specific accounts are to be shown and in a specified order.

In addition, the individual user table 231D or 231E may also have an open-up priority setting field, which is configured to work with the foregoing priority setting field. The priority setting field set allows the user, while in the open-up priority setting field, to set up his/her system to display accounts bearing a priority status up to the n^{th} priority (n is a natural number greater than 1). This way, the user can also determine the extent or degree of privacy desired while setting up his/her account.

To sum up, the present invention allows an inquiring user to search and obtain an account of phone number by inputting a phone number or account to be searched, so as to prevent problems related to incorrect input of accounts or other contacting information. The present invention can work with other applications, such as the email system or the interconnection system as described above, so as to simplify input of accounts. Also, the individual user table 231 may be modified or updated according to the use's need, so other inquiring users can be free from the trouble of inputting the modified or updated accounts.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A method of searching accounts by arranging phone numbers, the method comprising steps of:
providing a general user database that has at least one individual user table that includes a plurality of predetermined phone numbers and a plurality of predetermined accounts, wherein each said predetermined phone number has at least one corresponding said predetermined account;
inputting a phone number or an account for search; and
searching the phone number or the account in the general user database and showing at least one said predetermined account or at least one said predetermined phone number, wherein the predetermined phone number corresponding to the shown predetermined account is identical to the phone number previously input for search, and the predetermined account corresponding to the shown predetermined phone number is identical to the account previously input for search.

2. The method of claim 1, further comprising connecting an account search field of an interconnection system, so that when the phone number to be searched is input to the account search field of the interconnection system, the method searches the general user database and shows the corresponding at least one predetermined account to the interconnection system.

3. The method of claim 2, further connecting an account search field of an email system, so that when the phone number to be searched is input to the account search field of the email system, the method searches the general user database and shows the corresponding at least one predetermined account to the email system.

4. The method of claim 3, wherein the general user database is connected to or installed on a host trough a network connection and further connected to an authorization unit, and the step of searching the general user database is not performed until an authorization is obtained from the authorization unit.

5. The method of claim 1, further comprising connecting with an account search field of an email system, so that when the phone number to be searched is input to the account search field of the email system, the method searches the general user database and shows the corresponding at least one predetermined account to the email system.

6. The method of claim 5, wherein the general user database is connected to or installed on a host trough a network connection and further connected to an authorization unit, and the step of searching the general user database is not performed until an authorization is obtained from the authorization unit.

7. The method of claim 1, wherein each said predetermined account in the individual user table is connected to an open-up setting field, for setting whether the predetermined account will be shown.

8. The method of claim 7, wherein each said predetermined account in the individual user table is connected to a priority setting field, for setting an order of showing the predetermined account, and when the predetermined account is set as a top priority at the priority setting field, the predetermined account will be shown.

9. The method of claim 8, wherein each said predetermined account in the individual user table is connected to an open-up priority setting field.

10. The method of claim 1, wherein each said predetermined account in the individual user table is connected to a priority setting field and an open-up priority setting field, in which the priority setting field is for setting an order of showing the predetermined account, and when the predetermined account is set as a top priority at the priority setting field, the predetermined account will be shown.

11. A system of searching accounts by arranging phone numbers, the system comprising:
an inquiring user interface including an input unit;
a general user database storing at least one individual user table, which includes a plurality of predetermined phone numbers and a plurality of predetermined accounts, wherein each said predetermined phone number has at least one corresponding said predetermined account; and
a search unit connected to the general user database and including at least one search field,
wherein, when a phone number or an account for search is input to the search field of the input unit, the search unit searches in the general user database and shows at least one said predetermined account or at least one said predetermined phone number, in which the predetermined phone number corresponding to the shown predetermined account is identical to the phone number previously input for search, and the predetermined account corresponding to the shown predetermined phone number is identical to the account previously input for search.

12. The system of claim 11, wherein the general user database is further connected to an account search field of an interconnection system.

13. The system of claim 12, wherein the general user database is further connected to an account search field of an email system.

14. The system of claim 13, wherein the general user database is connected to the search unit through at least one network device and the general user database is further connected to an authorization unit.

15. The system of claim 14, wherein the general user database is further connected to an open-up setting field for setting whether the predetermined account will be shown.

16. The system of claim 14, wherein the general user database is further connected to a priority setting field, for setting an order of showing the predetermined account.

17. The system of claim 11, wherein the general user database is further connected to account search field of an email system.

18. The system of claim 17, wherein the general user database is connected to the search unit through at least one network device and the general user database is further connected to an authorization unit.

19. The system of claim 18, wherein the general user database is further connected to an open-up setting field, for setting whether the predetermined account will be shown.

20. The system of claim 18, wherein the general user database is further connected to a priority setting field, for setting an order of showing the predetermined account.

21. The system of claim 11, wherein each said predetermined account in the individual user table is connected to a priority setting field, for setting an order of showing the predetermined account.

22. The system of claim 21, wherein each said predetermined account in the individual user table is connected to an open-up priority setting field.
